(19) United States
(12) Patent Application Publication
(10) Pub. No.: US 2022/0141905 A1
(43) Pub. Date: May 5, 2022

(54) METHODS AND APPARATUSES FOR CONNECTION ESTABLISHMENT

(71) Applicant: Telefonaktiebolaget LM Ericsson (publ), Stockholm (SE)

(72) Inventor: Juying Gan, Shanghai (CN)

(21) Appl. No.: 17/431,832

(22) PCT Filed: Jul. 9, 2019
(86) PCT No.: PCT/CN2019/095318

§ 371 Date: Aug. 18, 2021

(30) Foreign Application Priority Data
Feb. 18, 2019 (CN) PCT/CN2019/075412

(51) Int. Cl. H04W 76/16; H04W 76/22

(52) U.S. Cl. CPC H04W 76/16; H04W 76/22

(57) ABSTRACT

Methods and apparatuses for connection establishment are disclosed. According to an embodiment, a first network node receives, from a terminal device, a first request for establishment of a first connection that is a connection of a first type according to a first technology. The first request comprises a first indication about whether the terminal device supports a second connection that is a connection of the first type according to a second technology. The first network node sends, to a second network node, a second request for establishment of the first connection. The second request comprises the first indication. The first network node receives, from the second network node, a second indication about whether the second connection is supported by the second network node. The first network node sends the second indication to the terminal device.

### TECHNICAL FIELD

Embodiments of the disclosure generally relate to communication, and, more particularly, to methods and apparatuses for connection establishment.

### BACKGROUND

This section introduces aspects that may facilitate better understanding of the present disclosure. Accordingly, the statements of this section are to be read in this light and are not to be understood as admissions about what is in the prior art or what is not in the prior art.

For evolved packet system (EPS), per 3rd generation partnership project (3GPP) technical specification (TS) 23.401 v16.1.0, a packet data network (PDN) connection can have PDN Type IP (i.e. IPv4, IPv6, IPv4v6), or Non-IP (but no Ethernet), as described below. The term IP refers to Internet protocol. The term IPv4 refers to IP version 4, the term IPv6 refers to IP version 6, and the term IPv4v6 refers to IP version 4/version 6.
3.1 Definitions
PDN Connection: The association between a PDN represented by an APN and a UE, represented by one IPv4 address and/or one IPv6 prefix (for IP PDN Type) or by the UE Identity (for Non-IP PDN Type).
Default Bearer: The EPS bearer which is first established for a new PDN connection and remains established throughout the lifetime of the PDN connection.

Per 3GPP TS 23.401 v16.1.0, a PDN contains a default bearer and optionally one or more dedicated bearers. The default bearer is a non-guaranteed bit rate (non-GBR) bearer. Network resource related to GBR can only be achieved by the means of dedicated bearer.
4.7.2.1 The EPS bearer in general
. . .
In this release of the specifications, dedicated bearers are only supported for the IP PDN Connectivity Service.
. . .
One EPS bearer is established when the UE connects to a PDN, and that remains established throughout the lifetime of the PDN connection to provide the UE with always-on IP connectivity to that PDN. That bearer is referred to as the default bearer. Any additional EPS bearer that is established for the same PDN connection is referred to as a dedicated bearer.
. . .
An EPS bearer is referred to as a GBR bearer if dedicated network resources related to a Guaranteed Bit Rate (GBR) value that is associated with the EPS bearer are permanently allocated (e.g. by an admission control function in the eNodeB) at bearer establishment/modification. Otherwise, an EPS bearer is referred to as a Non-GBR bearer.
. . .
A dedicated bearer can either be a GBR or a Non-GBR bearer. A default bearer shall be a Non-GBR bearer.

Per 3GPP TS 23.401 v16.1.0, dedicate bearer (e.g. GBR dedicated bearer) for PDN connection of non-IP PDN Type is not supported.
4.3.17.8 Support for Non-IP Data Delivery (NIDD)
4.3.17.8.1 General
. . .
Dedicated bearers are not supported for the Non-IP data.

For 5th generation system (5GS), per 3GPP TS 23.501 v15.4.0, protocol data unit (PDU) Session can be of Type IP (v4, v6, v4v6), Ethernet or Unstructured.
3.1 Definitions
. . .
PDU Session: Association between the UE and a Data Network that provides a PDU connectivity service.
PDU Session Type: The type of PDU Session which can be IPv4, IPv6, IPv4v6, Ethernet or Unstructured.

Per 3GPP TS 23.501 v15.4.0 and 3GPP TS 23.503 v15.4.0, GBR quality of service (QoS) Flow is also supported for PDU Session of Ethernet Type. Excerpt from 3GPP TS 23.501 v15.4.0 is as below:
3.1 Definitions
. . .
5G QoS Flow: The finest granularity for QoS forwarding treatment in the 5G System. All traffic mapped to the same 5G QoS Flow receive the same forwarding treatment (e.g. scheduling policy, queue management policy, rate shaping policy, RLC configuration, etc.). Providing different QoS forwarding treatment requires separate 5G QoS Flow.
5.7.1.1 QoS Flow
The 5G QoS model is based on QoS Flows. The 5G QoS model supports both QoS Flows that require guaranteed flow bit rate (GBR QoS Flows) and QoS Flows that do not require guaranteed flow bit rate (Non-GBR QoS Flows) . . . .
   Excerpt from 3GPP TS 23.503 v15.4.0 is as below:
4.3.3.2 QoS control requirements
4.3.3.2.1 QoS control at service data flow level
It shall be possible to apply QoS control on a per service data flow basis in the SMF, applicable for service data flows of both IP type and Ethernet type.
. . .
4.3.3.2.2 QoS control at QoS Flow level
. . .
It shall be possible for the PCC framework to support control of QoS for the packet traffic of the PDU Session
. . .
The PCC framework shall be able to handle QoS Flows that require a guaranteed bitrate (GBR bearers) and QoS Flows for which there is no guaranteed bitrate (non-GBR bearers).

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for connection establishment.

According to a first aspect of the disclosure, there is provided a method implemented at a terminal device. The method comprises sending, to a first network node, a first request for establishment of a first connection that is a connection of a first type according to a first technology. The first request comprises a first indication about whether the terminal device supports a second connection that is a connection of the first type according to a second technology. The method further comprises receiving, from the first network node, a response to the first request. The response comprises a second indication about whether the second connection is supported by a second network node.

In an embodiment of the disclosure, the method further comprises determining whether both the terminal device and the second network node support the second connection, based on the second indication. The method further comprises, when determining that both the terminal device and the second network node support the second connection, sending, to the first network node, a second request for transferring from the first connection to the second connection.

In an embodiment of the disclosure, the first type is Ethernet type.

In an embodiment of the disclosure, the first technology is 5th generation (5G) and the second technology is long term evolution (LTE).

In an embodiment of the disclosure, the first connection is a protocol data unit (PDU) session of Ethernet type and the second connection is a packet data network (PDN) connection of Ethernet type.

In an embodiment of the disclosure, the first network node is an access and mobility management function (AMF). The second network node is a session management node supporting both 5G and LTE in a home or visited network.

According to a second aspect of the disclosure, there is provided a method implemented at a first network node. The method comprises receiving, from a terminal device, a first request for establishment of a first connection that is a connection of a first type according to a first technology. The first request comprises a first indication about whether the terminal device supports a second connection that is a connection of the first type according to a second technology. The method further comprises sending, to a second network node, a second request for establishment of the first connection. The second request comprises the first indication. The method further comprises receiving, from the second network node, a second indication about whether the second connection is supported by the second network node. The method further comprises sending the second indication to the terminal device.

In an embodiment of the disclosure, the second request is sent to the second network node via a third network node and the second indication is received from the second network node via the third network node. Alternatively, the first request is from the terminal device via a third network node and the second indication is sent to the terminal device via the third network node.

In an embodiment of the disclosure, the method further comprises, in response to a requirement to transfer from the first technology to the second technology, sending, to the second network node, a third indication about whether a fourth network node supports the second connection. The method further comprises receiving, from the second network node, a fourth indication about whether the second connection or a third connection that is a connection of a second type according to the second technology is to be used. The method further comprises sending the fourth indication to the fourth network node.

In an embodiment of the disclosure, the first type is Ethernet type.

In an embodiment of the disclosure, the first technology is 5G and the second technology is LTE.

In an embodiment of the disclosure, the first connection is a PDU session of Ethernet type and the second connection is a PDN connection of Ethernet type.

In an embodiment of the disclosure, the first network node is an AMF. The second network node is a session management node supporting both 5G and LTE in a home or visited network. The third network node is an SMF in a visited network.

In an embodiment of the disclosure, the first network node is an SMF in a visited network. The second network node is a session management node supporting both 5G and LTE in a home or visited network. The third network node is an AMF.

In an embodiment of the disclosure, the fourth network node is a mobility management entity (MME). The second type is non-IP type.

According to a third aspect of the disclosure, there is provided a method implemented at a second network node. The method comprises receiving, from a first network node, a second request for establishment of a first connection that is a connection of a first type according to a first technology for a terminal device. The first request comprises a first indication about whether the terminal device supports a second connection that is a connection of the first type according to a second technology. The method further comprises determining a second indication about whether the second connection is supported by the second network node. The method further comprises sending the second indication to the first network node.

In an embodiment of the disclosure, the second indication is about whether the second connection is supported by both the terminal device and the second network node.

In an embodiment of the disclosure, the second request is received from the first network node via a third network node. The second indication is sent to the first network node via the third network node.

In an embodiment of the disclosure, the method further comprises receiving, from the first network node, a third indication about whether a fourth network node supports the second connection. The method further comprises determining a fourth indication about whether the second connection or a third connection that is a connection of a second type according to the second technology is to be used for the terminal device, based on the first and third indications. The method further comprises sending the fourth indication to the first network node.

In an embodiment of the disclosure, determining the fourth indication comprises, when the terminal device, the second network node and the fourth network node support the second connection, determining that the second connection is to be used for the terminal device. Determining the fourth indication further comprises, when the fourth network node supports the third connection but does not support the second connection, determining that the third connection is to be used for the terminal device.

In an embodiment of the disclosure, the first type is Ethernet type.

In an embodiment of the disclosure, the first technology is 5G and the second technology is LTE.

In an embodiment of the disclosure, the first connection is a PDU session of Ethernet type and the second connection is a PDN connection of Ethernet type.

In an embodiment of the disclosure, the first network node is an AMF. The second network node is a session management node supporting both 5G and LTE in a home or visited network. The third network node is an SMF in a visited network.

In an embodiment of the disclosure, the fourth network node is an MME. The second type is non-IP type.

According to a fourth aspect of the disclosure, there is provided a terminal device. The terminal device comprises at least one processor and at least one memory. The at least one memory contains instructions executable by the at least one processor, whereby the terminal device is operative to send, to a first network node, a first request for establishment of a first connection that is a connection of a first type according to a first technology. The first request comprises a first indication about whether the terminal device supports a second connection that is a connection of the first type according to a second technology. The terminal device is further operative to receive, from the first network node, a response to the first request. The response comprises a second indication about whether the second connection is supported by a second network node.

In an embodiment of the disclosure, the terminal device may be operative to perform the method according to the above first aspect.

According to a fifth aspect of the disclosure, there is provided a first network node. The first network node comprises at least one processor and at least one memory. The at least one memory contains instructions executable by the at least one processor, whereby the first network node is operative to receive, from a terminal device, a first request for establishment of a first connection that is a connection of a first type according to a first technology. The first request comprises a first indication about whether the terminal device supports a second connection that is a connection of the first type according to a second technology. The first network node is further operative to send, to a second network node, a second request for establishment of the first connection. The second request comprises the first indication. The first network node is further operative to receive, from the second network node, a second indication about whether the second connection is supported by the second network node. The first network node is further operative to send the second indication to the terminal device.

In an embodiment of the disclosure, the first network node may be operative to perform the method according to the above second aspect.

According to a sixth aspect of the disclosure, there is provided a second network node. The second network node comprises at least one processor and at least one memory. The at least one memory contains instructions executable by the at least one processor, whereby the second network node is operative to receive, from a first network node, a second request for establishment of a first connection that is a connection of a first type according to a first technology for a terminal device. The first request comprises a first indication about whether the terminal device supports a second connection that is a connection of the first type according to a second technology. The second network node is further operative to determine a second indication about whether the second connection is supported by the second network node. The second network node is further operative to send the second indication to the first network node.

In an embodiment of the disclosure, the second network node may be operative to perform the method according to the above third aspect.

According to a seventh aspect of the disclosure, there is provided a computer program product. The computer program product comprises instructions which when executed by at least one processor, cause the at least one processor to perform the method according to any of the above first to third aspects.

According to an eighth aspect of the disclosure, there is provided a computer readable storage medium. The computer readable storage medium comprises instructions which when executed by at least one processor, cause the at least one processor to perform the method according to any of the above first to third aspects.

According to a ninth aspect of the disclosure, there is provided a terminal device. The terminal device comprises a sending module for sending, to a first network node, a first request for establishment of a first connection that is a connection of a first type according to a first technology. The first request comprises a first indication about whether the terminal device supports a second connection that is a connection of the first type according to a second technology. The terminal device further comprises a reception module for receiving, from the first network node, a response to the first request. The response comprises a second indication about whether the second connection is supported by a second network node.

According to a tenth aspect of the disclosure, there is provided a first network node. The first network node comprises a first reception module for receiving, from a terminal device, a first request for establishment of a first connection that is a connection of a first type according to a first technology. The first request comprises a first indication about whether the terminal device supports a second connection that is a connection of the first type according to a second technology. The first network node further comprises a first sending module for sending, to a second network node, a second request for establishment of the first connection. The second request comprises the first indication. The first network node further comprises a second reception module for receiving, from the second network node, a second indication about whether the second connection is supported by the second network node. The first network node further comprises a second sending module for sending the second indication to the terminal device.

According to an eleventh aspect of the disclosure, there is provided a second network node. The second network node comprises a reception module for receiving, from a first network node, a second request for establishment of a first connection that is a connection of a first type according to a first technology for a terminal device. The first request comprises a first indication about whether the terminal device supports a second connection that is a connection of the first type according to a second technology. The second network node further comprises a determination module for determining a second indication about whether the second connection is supported by the second network node. The second network node further comprises a sending module for sending the second indication to the first network node.

According to some embodiment(s) of the disclosure, the connection establishment process can be facilitated.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 illustrates mapping between PDU Session Type and PDN Type;

FIG. 2 is a flowchart illustrating a method implemented at a terminal device according to an embodiment of the disclosure;

FIG. 3 is a flowchart illustrating a method implemented at a terminal device according to another embodiment of the disclosure;

FIG. 4 is a flowchart illustrating a method implemented at a first network node according to an embodiment of the disclosure;

FIG. 5 is a flowchart illustrating a method implemented at a first network node according to another embodiment of the disclosure;

FIG. 6 is a flowchart illustrating a method implemented at a second network node according to an embodiment of the disclosure;

FIG. 7 is a flowchart illustrating a method implemented at a second network node according to another embodiment of the disclosure;

FIG. 8 is a diagram illustrating an exemplary process according to an embodiment of the disclosure;

FIG. 9 is a diagram illustrating an exemplary process according to an embodiment of the disclosure;

FIG. 10 is a diagram illustrating an exemplary process according to an embodiment of the disclosure;

FIG. 11 is a diagram illustrating an exemplary process according to an embodiment of the disclosure; and

FIG. 12 is a block diagram showing an apparatus suitable for use in practicing some embodiments of the disclosure.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

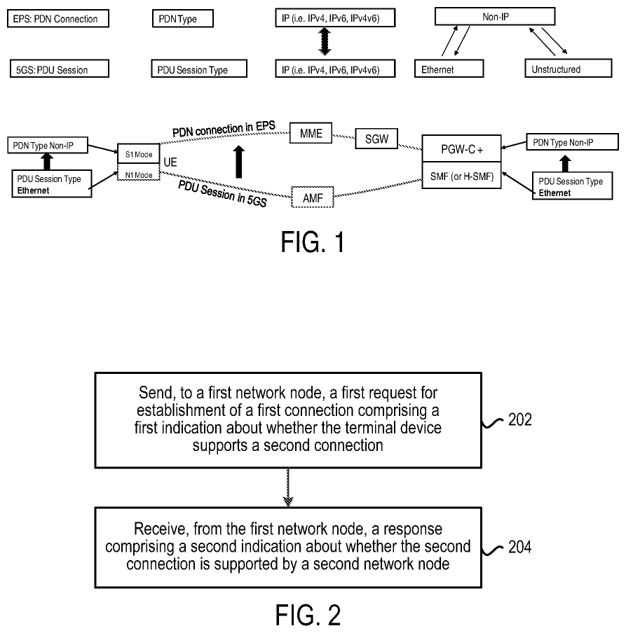

Currently according to 3GPP TS 23.501 and TS 23.502, the mapping between PDU Session Type and PDN Type is shown in FIG. 1. At 5GS to EPS mobility, PDU Session Type Ethernet and Unstructured are mapped to Non-IP PDN Type, and the UE and the PGW-C+SMF will remember the original PDU Session Type, and when UE moves back to 5GS, the original Ethernet PDU Session Type or Unstructured PDU Session Type will be resumed.

One mobile operator has proposed to support dedicated bearer for ethernet traffic also in EPC, refer to document S2-1813344, which was endorsed in 3GPP SA2#129bis meeting. The rationales of such proposal are as follows:
3GPP's ecosystem continues to expand to more than smartphones;
Many parts of the world might not be in 5GCore coverage;
Small/Medium Enterprises in developed countries might not get dedicated in-building cells;
Reasonable number of applications (machines) expected to only use Ethernet (without IP);
Many machines require QoS with some guarantees, e.g. a GBR bearer

In document S2-1813344, two solution alternatives are mentioned as follows:
Option-1 Introduce new PDN Type Ethernet in EPS;
Option-2 Use Non-IP PDN Type in EPS and allow dedicated bearer for PDN connection of non-IP PDN Type

Under the assumption that new PDN Type Ethernet is to be introduced in EPS (i.e. the above Option-1 is adopted), when UE moves from 5GS to EPS, there is no mechanism for the UE and the network to know if the EPS supports PDN Type Ethernet, and therefore the PDU Session Type cannot be mapped to PDN Type Ethernet. Consequently, the QoS requirement with some guarantees for Ethernet traffic in EPS is not possible.

The present disclosure proposes a solution for connection establishment. Hereinafter, the solution will be described in detail with reference to FIGS. 2-12.

As used herein, the term “communication system” refers to a system following any suitable communication standards, such as the first generation (1G), 2G, 2.5G, 2.75G, 3G, 4G, 4.5G, 5G communication protocols, and/or any other protocols either currently known or to be developed in the future. Furthermore, the communications between a terminal device and a network node in the communication system may be performed according to any suitable generation communication protocols, including, but not limited to, 1G, 2G, 2.5G, 2.75G, 3G, 4G, 4.5G, 5G communication protocols, and/or any other protocols either currently known or to be developed in the future.

In the following, different terms may refer to a same or similar network function or network node with the same or similar functionality in different communication systems. Thus, the specific terms used herein do not limit the present disclosure only to the communication system related to the specific terms, which however can be more generally applied to other communication systems.

The term “terminal device” may also be referred to as, for example, access terminal, user equipment (UE), mobile station, mobile unit, subscriber station, or the like. It may refer to any end device that can access a wireless communication network and receive services therefrom. By way of example and not limitation, the terminal device may include a portable computer, an image capture terminal device such as a digital camera, a gaming terminal device, a music storage and playback appliance, a mobile phone, a cellular phone, a smart phone, a tablet, a wearable device, a personal digital assistant (PDA), or the like.

In an Internet of things (IoT) scenario, a terminal device may represent a machine or other device that performs monitoring and/or measurements, and transmits the results of such monitoring and/or measurements to another terminal device and/or a network equipment. In this case, the terminal device may be a machine-to-machine (M2M) device, which may, in a 3GPP context, be referred to as a machine-type communication (MTC) device. Particular examples of such machines or devices may include sensors, metering devices such as power meters, industrial machineries, bikes, vehicles, or home or personal appliances, e.g. refrigerators, televisions, personal wearables such as watches, and so on.

FIG. 2 is a flowchart illustrating a method implemented at a terminal device according to an embodiment of the disclosure. At block 202, the terminal device sends, to a first network node, a first request for establishment of a first connection that is a connection of a first type according to a first technology. The first request comprises a first indication about whether the terminal device supports a second connection that is a connection of the first type according to a second technology. For example, the first network node may be an access and mobility management function (AMF). The first type may be Ethernet type. The first technology may be 5G and the second technology may be LTE. Thus, the first connection may be a PDU session of Ethernet type and the second connection may be a PDN connection of Ethernet type. As an exemplary example, the first request may be a PDU Session Establishment Request. The first indication may take any suitable form.

At block 204, the terminal device receives, from the first network node, a response to the first request. The response comprises a second indication about whether the second connection is supported by a second network node. For example, the second network node may be a session management node supporting both 5G and LTE in a home or visited network. Similar to the first indication, the second indication may take any suitable form. As an exemplary example, the response to the first request may be a PDU Session Establishment Accept message.

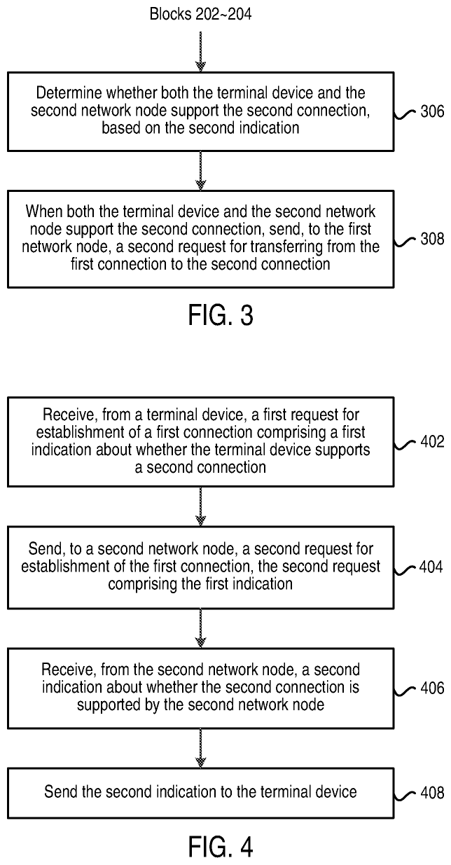

FIG. 3 is a flowchart illustrating a method implemented at a terminal device according to another embodiment of the disclosure. As shown, the method comprises blocks 202-204, 306 and 308. At block 306, the terminal device determines whether both the terminal device and the second network node support the second connection, based on the second indication. At block 308, when determining that both the terminal device and the second network node support the second connection, the terminal device sends, to the first network node, a second request for transferring from the first connection to the second connection. The second request may be sent at 5GS to EPS mobility. As an exemplary example, the second request may be an initial Attach Request message with handover.

FIG. 4 is a flowchart illustrating a method implemented at a first network node according to an embodiment of the disclosure. For example, the first network node may be an AMF, or an SMF in a visited network, as described later. At block 402, the first network node receives, from a terminal device, a first request for establishment of a first connection that is a connection of a first type according to a first technology. The first request comprises a first indication about whether the terminal device supports a second connection that is a connection of the first type according to a second technology. For example, the first type may be Ethernet type. The first technology may be 5G and the second technology may be LTE. Thus, the first connection may be a PDU session of Ethernet type and the second connection may be a PDN connection of Ethernet type. As an exemplary example, the first request may be a PDU Session Establishment Request. The first indication may take any suitable form. In the first option that the first network node is an AMF, the first request is received directly from the terminal device. In the second option that the first network node is an SMF in the visited network, the first request is received indirectly from the terminal device via a third network node which may be an AMF.

At block 404, the first network node sends, to a second network node, a second request for establishment of the first connection. The second request comprising the first indication. For example, the second network node may be a session management node supporting both 5G and LTE in a home or visited network. In the above first option, the second request is sent indirectly to the second network node via a third network node which may be an SMF in a visited network. As an exemplary example, the second request may be a PDUSession_CreateSMContext Request. In the above second option, the second request may be sent directly to the second network node. As an exemplary example, the second request may be a PDUSession_Create Request.

At block 406, the first network node receives, from the second network node, a second indication about whether the second connection is supported by the second network node. Similar to the first indication, the second indication may take any suitable form. In the above first option, the second indication is received indirectly from the second network node via the third network node which may be an SMF in the visited network. In the above second option, the second indication is received directly from the second network node.

At block 408, the first network node sends the second indication to the terminal device. In the above first option, the second indication is sent directly to the terminal device. In the above second option, the second indication is sent indirectly to the terminal device via the third network node which may be an AMF.

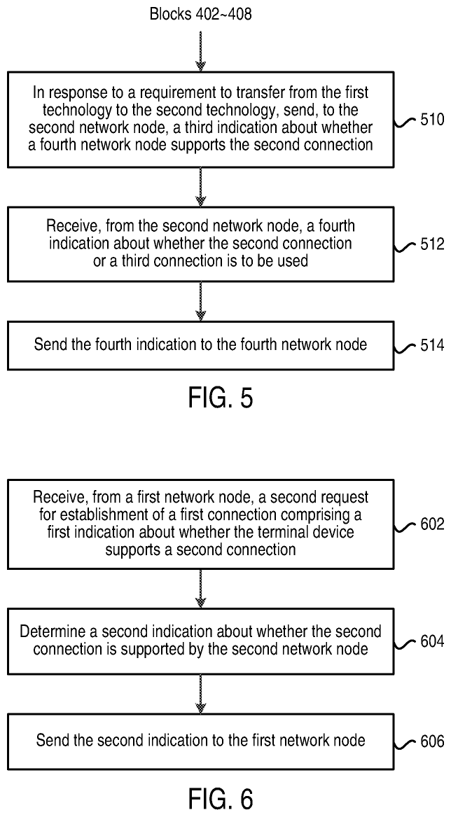

FIG. 5 is a flowchart illustrating a method implemented at a first network node according to another embodiment of the disclosure. As shown, the method comprises blocks 402-408, 510, 512 and 514. At block 510, in response to a requirement to transfer from the first technology to the second technology, the first network node sends, to the second network node, a third indication about whether a fourth network node supports the second connection. For example, the third indication may be sent in a context request message. Similar to the first and second indications, the third indication may take any suitable form. The fourth network node may be a mobility management entity (MME). At block 512, the first network node receives, from the second network node, a fourth indication about whether the second connection or a third connection that is a connection of a second type according to the second technology is to be used. For example, the fourth indication may be received in a context response message. The second type may be non-IP type. Thus, the third connection may be a PDN connection of non-IP type. Similar to the first to third indications, the fourth indication may take any suitable form. At block 514, the first network node sends the fourth indication to the fourth network node.

FIG. 6 is a flowchart illustrating a method implemented at a second network node according to an embodiment of the disclosure. For example, the second network node may be a session management node supporting both 5G and LTE in a home or visited network. At block 602, the second network node receives, from a first network node, a second request for establishment of a first connection that is a connection of a first type according to a first technology for a terminal device. The first request comprises a first indication about whether the terminal device supports a second connection that is a connection of the first type according to a second technology. Block 602 corresponds to block 404 and its details are omitted here. At block 604, the second network node determines a second indication about whether the second connection is supported by the second network node. Optionally, the second indication may be about whether the second connection is supported by both the terminal device and the second network node. At block 606, the second network node sends the second indication to the first network node. Block 606 corresponds to block 406 and its details are omitted here.

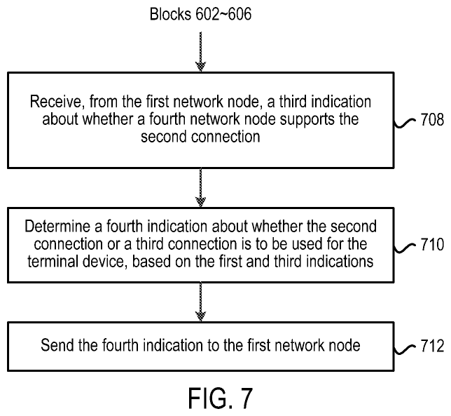

FIG. 7 is a flowchart illustrating a method implemented at a second network node according to another embodiment of the disclosure. As shown, the method comprises blocks 602-606, 708, 710 and 712. At block 708, the second network node receives, from the first network node, a third indication about whether a fourth network node supports the second connection. Block 708 corresponds to block 510 and its details are omitted here. At block 710, the second network node determines a fourth indication about whether the second connection or a third connection that is a connection of a second type according to the second technology is to be used for the terminal device, based on the first and third indications. For example, the second type may be non-IP type. Thus, the third connection may be a PDN connection of non-IP type. If the terminal device, the second network node and the fourth network node support the second connection, it may be determined that the second connection is to be used for the terminal device. However, if the fourth network node supports the third connection but does not support the second connection, it may be determined that the third connection is to be used for the terminal device. At block 712, the second network node sends the fourth indication to the first network node.

Now, several embodiments will be further described to explain the solution of the present disclosure. As a first embodiment, negotiation of EPS Ethernet capability is performed when UE establishes PDU Session in 5GS. When UE establishes PDU Session of Ethernet Type in 5GS, the UE provides also the EPS Ethernet capability (i.e. if UE supports PDN Type Ethernet in EPS) to the SMF. If the SMF supports PDN Type Ethernet in EPS, then the SMF provides back to the UE that the network is capable of EPS Ethernet PDN Type.

As a second embodiment, at 5GS to EPS mobility with N26, If MME, UE and PGW-C+SMF support Ethernet PDN Type, PGW-C+SMF maps the PDU Session of Ethernet Type to PDN connection of Ethernet PDN type. If UE and PGW-C+SMF supports Ethernet PDN Type but MME supports only non-IP Type (but not supporting Ethernet PDN Type), PGW-C+SMF will use non-IP Type as in legacy (i.e. network behavior described in 3GPP Rel-15). In this way, for ethernet traffic, the guaranteed QoS if any in 5GS can also be maintained when UE moves to EPS.

As a third embodiment, at 5GS to EPS mobility without N26, If UE knows that the network supports also Ethernet PDN Type in EPS, the UE uses Ethernet PDN Type in initial Attach Request with handover to move the PDU Session of Ethernet Type to EPS. In this way, for ethernet traffic, the guaranteed QoS if any in 5GS can also be maintained when UE moves to EPS.

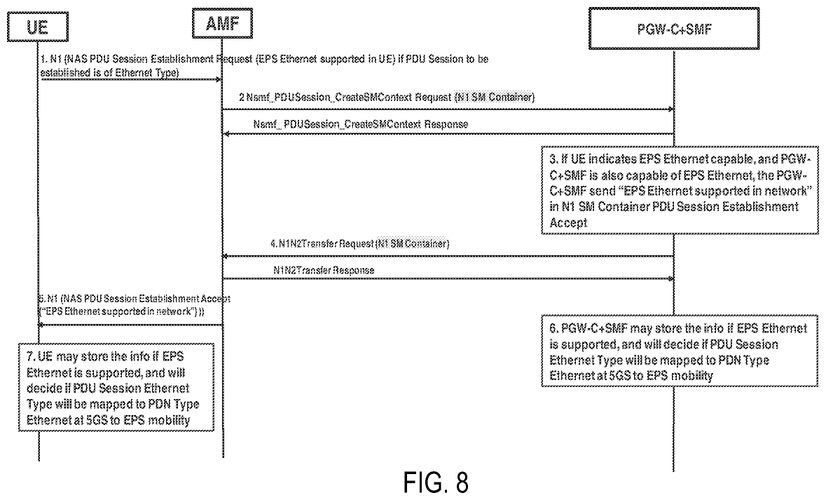

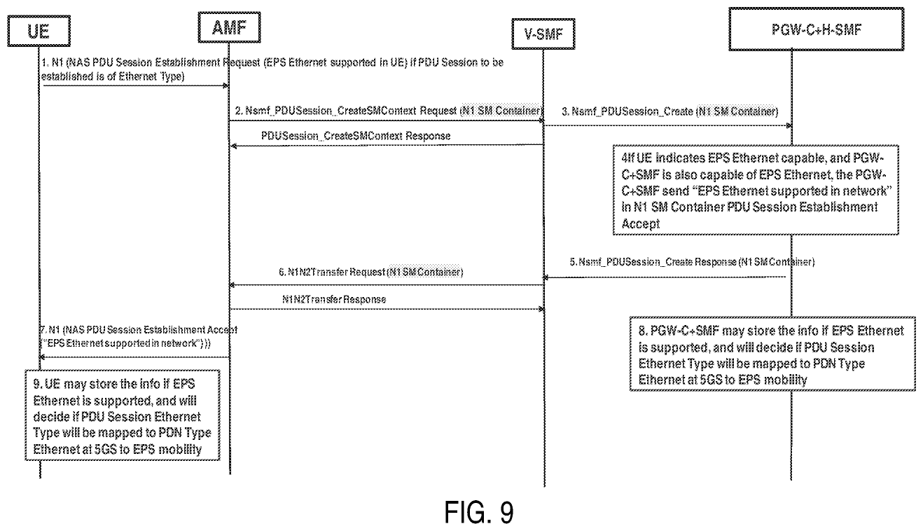

FIGS. 8-9 are diagrams illustrating exemplary processes according to the above first embodiment. This process assumes that new PDN type Ethernet is to be introduced in EPS. In order that the PDU Session type Ethernet can be mapped to PDN Type Ethernet at 5GS to EPS mobility, the UE and the network negotiates EPS Ethernet capability at PDU Session Establishment as illustrated in FIG. 8 (for non-roaming or Local Breakout Roaming) and FIG. 9 (for Home Routed Roaming). Note that only relevant steps are shown in the figures for easy of understanding.

For FIG. 8, at step 1, when a UE establishes a PDU Session of Ethernet Type, the UE includes a new indication if EPS Ethernet is supported in the UE in NAS message PDU Session Establishment Request. Optionally, the new indication of EPS Ethernet supported may be sent as a new 5GSM (Session Management) Capability or may be sent in PCO (Protocol Configuration Options). At step 2, the new indication is sent in N1 SM Container of Nsmf_PDUSession_CreateSMContext Request from the AMF to the PGW-C/SMF. At step 3, if both the PGW-C+SMF and the UE supports EPS Ethernet, the PGW-C+SMF returns also “EPS Ethernet” supported to the UE. At step 4, the “EPS Ethernet” supported indication is sent in N1N2Transfer Request from the PGW-C+SMF to the AMF. At step 5, the “EPS Ethernet supported in network” indication is sent from the AMF to the UE. At step 6, the PGW-C+SMF may store the information if EPS Ethernet is supported for later use (i.e. for 5GS to EPS mobility). At step 7, the UE may store information if EPS Ethernet is supported for later use (i.e. for 5GS to EPS mobility).

For FIG. 9, in the case of Home Routed Roaming, compared to non-roaming case in FIG. 8, it is the PGW-C+H-SMF (instead of V-SMF) that handles the EPS Ethernet capability. The new indication of EPS Ethernet supported is transparent to the V-SMF.

According to the above processes, the following updates are proposed to be made to the current technical specification 3GPP TS 23.502 V15.4.1.
4.11.5 Impacts to 5GC Procedures
4.11.5.3 UE Requested PDU Session Establishment procedure
The following impacts are applicable to clause 4.3.2.2 (UE Requested PDU Session Establishment procedure) to support interworking with EPS:
   Step 1: In PDU Session Establishment Request message, the UE includes also the UE capability of Ethernet support in EPS to the SMF (or H-SMF in home routing roaming);
   Step 3: The AMF also includes EPS Interworking Indication in Nsmf_PDUSession_CreateSMContext Request message sent to SMF.
The AMF determines that indication, based on, e.g. UE radio capability (e.g. “S1 mode supported”) and UE subscription data (e.g. Core Network Type Restriction to EPS). The AMF includes the EPS Interworking Indication in the Nsmf_PDUSession_CreateSMContext or Nsmf_PDUSession_UpdateSMContext Request to indicate whether the UE supports EPS Interworking
   Step 4: If the EPS Interworking indication received from AMF indicates that the UE supports EPS interworking and the SMF determines, e.g. based on UE subscription data (e.g. whether EPS interworking is allowed for this DNN and S-NSSAI), that the PDU Session supports EPS interworking, the PGW-C+SMF FQDN for S5/S8 interface is included in the Nudm_UECM_Registraion Request.
   Step 13 In PDU Session Establishment Accept message, the SMF (or H-SMF in home routed roaming) also includes the information if the Ethernet PDN type is supported. The SMF and the UE stores the information if Ethernet PDN type is supported for later use when UE moves from 5GS to EPS.

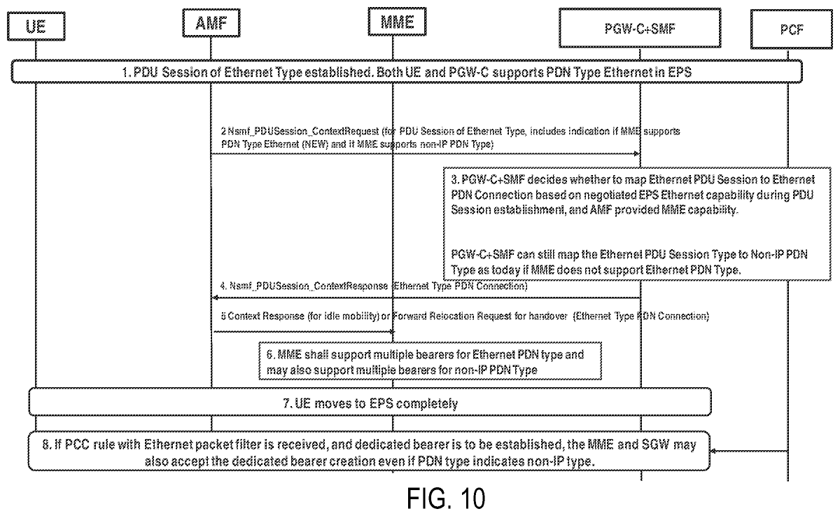

FIG. 10 is a diagram illustrating an exemplary process according to the above second embodiment. At step 2, (corresponding to step 2 of TS 23.502 clause 4.11.1.2.1 5GS to EPS handover using N26 interface, or step 5a of TS 23.502 clause 4.11.1.3.2 5GS to EPS Idle mode mobility using N26 interface), when the AMF uses Nsmf_PDUSession_Context Request to retrieve SM Context from SMF, in addition to that the AMF provides the target MME capability if non-IP PDN Type is supported or not, the AMF also provides the target MME capability if Ethernet PDN Type is supported. At step 3, If MME, UE and PGW-C+SMF support Ethernet PDN Type, PGW-C+SMF maps the PDU Session of Ethernet Type to PDN connection of Ethernet PDN type. If UE and PGW-C+SMF supports Ethernet PDN Type but MME supports only non-IP Type (but not supporting Ethernet PDN Type), PGW-C+SMF will use non-IP Type and includes all the bearers in the PDN connection. At step 5, the AMF may include Ethernet Type PDN connection or non-IP Type PDN connection. At step 6, the MME shall accept multiple bearers in the PDN Connection for Ethernet Type. The MME may accept multiple bearers for non-IP PDN Type. At step 8, if policy control and charging (PCC) rule with Ethernet packet filter is received, and dedicated bearer is to be established, the MME and SGW may accept the dedicated bearer creation even if PDN type indicates non-IP type.

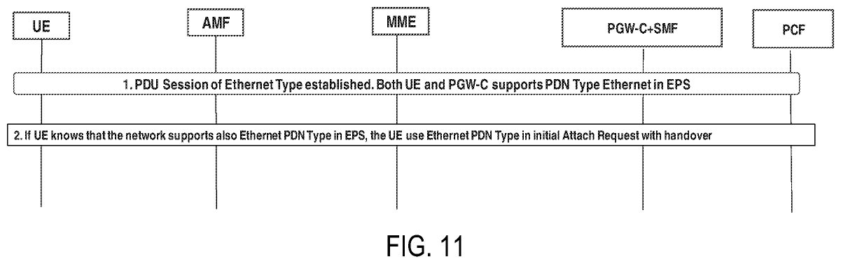

FIG. 11 is a diagram illustrating an exemplary process according to the above third embodiment. At step 2, if UE knows that the network supports also Ethernet PDN Type in EPS, the UE use Ethernet PDN Type in initial Attach Request with handover. It should be noted that two blocks shown in succession in the figures may, in fact, be executed substantially concurrently, or the blocks may sometimes be executed in the reverse order, depending upon the functionality involved.

According to the above processes, the following updates are proposed to be made to the current technical specification 3GPP TS 23.502 V15.4.1.
For 5GS-EPS mobility with N26:
4.11.1.2.1 5GS to EPS handover using N26 interface
The procedure involves a handover to EPC and setup of default EPS bearer and dedicated bearers for GBR QoS Flows in EPC in steps 1-16 and re-activation, if required, of dedicated EPS bearers for non-GBR QoS Flows in step 17. This procedure can be triggered, for example, due to new radio conditions, load balancing or in the presence of QoS Flow for normal voice or IMS emergency voice, the source NG-RAN node may trigger handover to EPC.
When PDN Type Ethernet is not supported in the EPS, the following applies:
For Ethernet and Unstructured PDU Session Types, the PDN Type non-IP is used, when supported, in EPS. The SMF shall thus set the PDN Type of the EPS Bearer Context to non-IP in these cases. After the handover to EPS, the PDN Connection will have PDN Type non-IP, but it shall be locally associated in UE and SMF to PDU Session Type Ethernet or Unstructured respectively.
When PDN Type Ethernet is supported in EPS, Ethernet Type is used, and only PDU Session type “Unstructured” needs to be transferred to EPC as “non-IP” PDN type (when supported by UE and network).
. . .
2. The AMF determines from the ‘Target eNB Identifier’ IE that the type of handover is Handover to E-UTRAN. The AMF selects an MME as described in TS 23.401 [13] clause 4.3.8.3.
In the case of HR roaming, the AMF by using Nsmf_PDUSession_Context Request requests the V-SMF to provide SM Context that also includes the mapped EPS Bearer Contexts. The AMF provides the target MME capability to SMF in the request to allow the V-SMF to determine whether to include EPS Bearer context for Ethernet PDN Type or non-IP PDN Type or not. For PDU Sessions with PDU Session Type Ethernet, if the target MME supports Ethernet PDN type, the SMF provides SM Context for Ethernet PDN Type, otherwise if the target MME does not support Ethernet Type but support non-IP Type, the SMF provides SM Context for non-IP PDN Type. For PDU Sessions with PDU Session Type Unstructured, the SMF provides SM Context for non-IP PDN Type.
In the case of non roaming or LBO roaming, the AMF request PGW-C+SMF to provide SM Context by using Nsmf_PDUSession_ContextRequest. The AMF provides the target MME capability to PGW-C+SMF in the request to allow the PGW-C+SMF to determine whether to include EPS Bearer context for Ethernet Type or non-IP PDN Type or not. For PDU Sessions with PDU Session Type Ethernet, if the target MME supports Ethernet PDN type, the SMF provides SM Context for Ethernet PDN Type, otherwise if the target MME does not support Ethernet but support non-IP PDN Type, the SMF provides SM Context for non-IP PDN Type. For PDU Sessions with PDU Session Type Unstructured, the SMF provides SM Context for non-IP PDN Type. The PGW-C+SMF send N4 Session modification to PGW-U+UPF to establish the CN tunnel for each EPS bearer and provide EPS Bearer Contexts to AMF, as described in step 8 of clause 4.11.1.4.1. The PGW-U+UPF is ready to receive the uplink packet from E-UTRAN.
This step is performed with all the PGW-C+SMFs corresponding to PDU Sessions of the UE which are associated with 3GPP access and have EBI(s) allocated to them.
NOTE 2: The AMF knows the MME capability to support Ethernet PDN type and/or non-IP PDN type or not through local configuration.
19. The PGW-C+SMF initiates dedicated bearer activation procedure for non-GBR QoS Flows, if necessary, by mapping the parameters of the non-GBR Flows to EPC QoS parameters. This setup may be triggered by the PCF, if PCC is deployed. This procedure is specified in TS 23.401 [13], clause 5.4.1 with modification captured in clause 4.11.1.5.4. This step is applicable for PDN Type IP or Ethernet, but not for non-IP PDN Type.
4.11.1.2.2 EPS to 5GS handover using N26 interface
NOTE 1: If the non-IP PDN Type is locally associated in UE and SMF to PDU Session Type Ethernet, it means that Ethernet PDN Type is not supported in EPS.
NOTE 2: The IP address continuity can't be supported, if PGW-C+SMF in the HPLMN doesn't provide the mapped QoS parameters.
7. The PGW-C+SMF (V-SMF in the case of home-routed roaming scenario only) sends a Nsmf_PDUSession_CreateSMContext Response (PDU Session ID, S-NSSAI, N2 SM Information (PDU Session ID, S-NSSAI, QFI(s), QoS Profile(s), EPS Bearer Setup List, Mapping between EBI(s) and QFI(s), CN Tunnel-Info, cause code)) to the AMF.
For home-routed roaming scenario the step 8 need be executed first. The CN Tunnel-Info provided to the AMF in N2 SM Information is the V-CN Tunnel-Info.
SMF includes mapping between EBI(s) and QFI(s) as part of N2 SM Information container. If the P-GW-C+SMF (H-SMF in the case of home-routed scenario) determines that seamless session continuity from EPS to 5GS is not supported for the PDU Session, then it does not provide SM information for the corresponding PDU Session but includes the appropriate cause code for rejecting the PDU Session transfer within the N2 SM Information. If the Direct Forwarding Flag indicates indirect forwarding and there is no indirect data forwarding connectivity between source and target, the SMF shall further include a “Data forwarding not possible” indication in the N2 SM information container. In home routed roaming case, the S-NSSAI included in N2 SM Information container is the S-NSSAI received in step 4.
AMF stores an association of the PDU Session ID, S-NSSAI and the SMF ID.
If the PDN Type of a PDN Connection in EPS is non-IP, and is locally associated in SMF to PDU Session Type Ethernet, the PDU Session Type in 5GS shall be set to Ethernet. In case the PDN type of a PDN Connection in EPS is non-IP, and is locally associated in UE and SMF to PDU Session Type Unstructured, the PDU Session Type in 5GS shall be set to Unstructured.
NOTE X: If the non-IP PDN Type is locally associated in SMF to PDU Session Type Ethernet, it means that Ethernet PDN Type is not supported in EPS.
4.11.1.3.2 5GS to EPS Idle mode mobility using N26 interface
5a. The AMF verifies the integrity of the TAU request message and requests the PGW-C+SMF to provide SM Context by using Nsmf_PDUSession_ContextRequest that also includes the mapped EPS Bearer Contexts. The AMF provides the target MME capability to SMF in the request to allow the SMF to determine whether to include EPS Bearer context for Ethernet PDN type or non-IP PDN Type or not. This step is performed with all the PGW-C+SMFs corresponding to PDU Sessions of the UE which are associated with 3GPP access and have EBI(s) allocated to them. In this step, if the AMF correctly validates the UE, then the AMF starts a timer.
NOTE 1: The AMF knows the MME capability to support Ethernet PDN Type and/or non-IP PDN type or not through local configuration.
5b. For Non-roaming or roaming with local breakout scenario, if CN Tunnel Info is allocated by the PGW-U+UPF, the SMF sends N4 Session Modification Request to PGW-U+UPF to establish the tunnel for each EPS bearers, and PGW-U+UPF provides the PGW-U Tunnel Info for each EPS bearers to PGW-C+SMF.
NOTE2: In home routed roaming case, the CN Tunnel Info for each EPS bearer has been prepared by the PGW-C+SMF and provided to the V-SMF as specified in clause 4.11.1.4.1.
5c. SMF returns mapped EPS bearer contexts, which includes PGW-C control plane tunnel information of the PDN connection corresponding to the PDU session, EBI for each EPS bearer, PGW-U tunnel information for each EPS bearer, and EPS QoS parameters for each EPS bearer. For PDU Sessions with PDU Session Type Ethernet, if the target MME supports Ethernet PDN type, the SMF provides SM Context for Ethernet PDN Type, otherwise if the target MME does not support Ethernet Type but support non-IP Type, the SMF provides SM Context for non-IP PDN Type. For PDU Sessions with PDU Session Type Unstructured, the SMF provides SM Context for non-IP PDN Type.
4.11.1.3.3 EPS to 5GS Mobility Registration Procedure (Idle and Connected State) using N26 interface
NOTE: For Connected State mobility registration, the release of CN tunnels for EPS bearers and UDM registration for the session corresponding to the PDU session is performed in the handover execution phase.
If the PDN Type of a PDN Connection in EPS is non-IP, and it was originally established as Ethernet PDU Session when UE was camping in 5GS (known based on local context information that was set to PDU Session Type Ethernet in UE and SMF), the PDU Session Type in 5GS shall be set to Ethernet by the SMF and UE. In case the PDN type of a PDN Connection in EPS is non-IP, and is locally associated in UE and SMF to PDU Session Type Unstructured, the PDU Session Type in 5GS shall be set to Unstructured by the SMF and UE.
NOTE X: If the non-IP PDN Type is originally established as Ethernet PDU Session, it means that Ethernet PDN Type is not supported in EPS.

For 5GS-EPS mobility without N26:
4.11.2.4 Impacts to EPS Procedures
4.11.2.4.1 E-UTRAN Attach
   Step 1:
The UE constructs the Attach Request message according to the following principles:
   If UE operates in single-registration mode, the UE indicates that it is moving from 5GC, and provides a native 4G-GUTI or a 4G-GUTI mapped from 5G GUTI (indicated as native GUTI), if available, otherwise the IMSI, or
   If the UE operates in dual-registration mode, the UE indicates that it is moving from 5GC and provides native 4G-GUTI, or
   If the UE sent a TAU in Step 2 and it was rejected because the MME could not derive the UE identity, the UE provides IMSI.
If the UE wants to transfer a PDU Session to EPC as part of the Attach procedure, it includes a PDN CONNECTIVITY Request message in the Attach Request and provides a Request type “Handover”, DNN/APN and PDU Session ID of the PDU Session (TS 23.401 [13], clause 5.3.2.1). The UE provides the PDU Session ID in PCO as described in clause 4.11.1.1. For PDU Session of Ethernet Type, if the UE and the network support Ethernet PDN Type in EPS which is negotiated during PDU Session Establishment as described in clause 4.11.5, the UE includes PDN Type Ethernet in PDN CONNECTIVITY Request message.

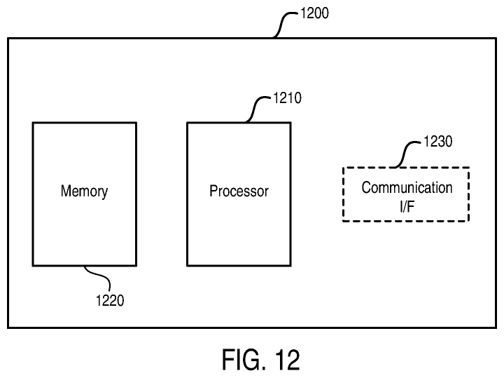

FIG. 12 is a block diagram showing an apparatus suitable for use in practicing some embodiments of the disclosure. For example, any one of the terminal device, the first network node and the second network node described above may be implemented through the apparatus 1200. As shown, the apparatus 1200 may include a processor 1210, a memory 1220 that stores a program, and optionally a communication interface 1230 for communicating data with other external devices through wired and/or wireless communication.

The program includes program instructions that, when executed by the processor 1210, enable the apparatus 1200 to operate in accordance with the embodiments of the present disclosure, as discussed above. That is, the embodiments of the present disclosure may be implemented at least in part by computer software executable by the processor 1210, or by hardware, or by a combination of software and hardware.

The memory 1220 may be of any type suitable to the local technical environment and may be implemented using any suitable data storage technology, such as semiconductor based memory devices, flash memories, magnetic memory devices and systems, optical memory devices and systems, fixed memories and removable memories. The processor 1210 may be of any type suitable to the local technical environment, and may include one or more of general purpose computers, special purpose computers, microprocessors, digital signal processors (DSPs) and processors based on multi-core processor architectures, as non-limiting examples.

As another embodiment, the terminal device comprises a sending module and a reception module. The sending module may be configured to send, to a first network node, a first request for establishment of a first connection that is a connection of a first type according to a first technology. The first request comprises a first indication about whether the terminal device supports a second connection that is a connection of the first type according to a second technology. The reception module may be configured to receive, from the first network node, a response to the first request. The response comprises a second indication about whether the second connection is supported by a second network node.

As another embodiment, the first network node comprises a first reception module, a first sending module, a second reception module and a second sending module. The first reception module may be configured to receive, from a terminal device, a first request for establishment of a first connection that is a connection of a first type according to a first technology. The first request comprises a first indication about whether the terminal device supports a second connection that is a connection of the first type according to a second technology. The first sending module may be configured to send, to a second network node, a second request for establishment of the first connection. The second request comprises the first indication. The second reception module may be configured to receive, from the second network node, a second indication about whether the second connection is supported by the second network node. The second sending module may be configured to send the second indication to the terminal device.

As another embodiment, the second network node comprises a reception module, a determination module and a sending module. The reception module may be configured to receive, from a first network node, a second request for establishment of a first connection that is a connection of a first type according to a first technology for a terminal device. The first request comprises a first indication about whether the terminal device supports a second connection that is a connection of the first type according to a second technology. The determination module may be configured to determine a second indication about whether the second connection is supported by the second network node. The sending module may be configured to send the second indication to the first network node. The modules described above may be implemented by hardware, or software, or a combination of both.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

Abbreviation Explanation

AMF Access and Mobility management Function

### EPS Evolved Packet System

### GBR Guaranteed Bit Rate

### H-SMF Home Session Management Function

### MME Mobility Management Entity

PGW-C Packet GateWay-Control plane

### PDN Packet Data Network

### PDU Packet Data Unit

### QoS Quality of Service

### SGW Serving GateWay

### UE User Equipment

### V-SMF Visiting Session Management Function

### 5GS The 5th Generation System

1. A method in a terminal device comprising:
sending, to a first network node, a first request for establishment of a first connection that is a connection of a first type according to a first technology, the first request comprising a first indication about whether the terminal device supports a second connection that is a connection of the first type according to a second technology; and
receiving, from the first network node, a response to the first request, the response comprising a second indication about whether the second connection is supported by a second network node.

2. The method according to claim 1, further comprising:
determining whether both the terminal device and the second network node support the second connection, based on the second indication; and
when determining that both the terminal device and the second network node support the second connection, sending, to the first network node, a second request for transferring from the first connection to the second connection.

3. The method according to claim 1, wherein the first type is Ethernet type.

4. The method according to claim 1, wherein the first technology is 5th generation, 5G, and the second technology is long term evolution, LTE.

5. The method according to claim 1, wherein the first connection is a protocol data unit, PDU, session, of Ethernet type and the second connection is a packet data network, PDN, connection of Ethernet type.

6. The method according to claim 1, wherein the first network node is an access and mobility management function, AMF; and
wherein the second network node is a session management node supporting both 5G and LTE in a home or visited network.

7. A method in a first network node comprising:
receiving, from a terminal device, a first request for establishment of a first connection that is a connection of a first type according to a first technology, the first request comprising a first indication about whether the terminal device supports a second connection that is a connection of the first type according to a second technology;
sending, to a second network node, a second request for establishment of the first connection, the second request comprising the first indication;
receiving, from the second network node, a second indication about whether the second connection is supported by the second network node; and
sending the second indication to the terminal device.

8. The method according to claim 7, wherein the second request is sent to the second network node via a third network node and the second indication is received from the second network node via the third network node; or
wherein the first request is from the terminal device via a third network node and the second indication is sent to the terminal device via the third network node.

9. The method according to claim 7, further comprising:
in response to a requirement to transfer from the first technology to the second technology, sending, to the second network node, a third indication about whether a fourth network node supports the second connection;
receiving, from the second network node, a fourth indication about whether the second connection or a third connection that is a connection of a second type according to the second technology is to be used; and
sending the fourth indication to the fourth network node.

10. The method according to claim 7, wherein the first type is Ethernet type; and
wherein the first technology is 5th generation, 5G, and the second technology is long term evolution, LTE.

11. (canceled)

12. The method according to claim 7, wherein the first connection is a protocol data unit, PDU, session, of Ethernet type and the second connection is a packet data network, PDN, connection of Ethernet type.

13. The method according to claim 7, wherein the first network node is an access and mobility management function, AMF;
wherein the second network node is a session management node supporting both 5G and LTE in a home or visited network; and
wherein the third network node is a session management function, SMF, in a visited network; or
wherein the first network node is an SMF in a visited network;
wherein the second network node is a session management node supporting both 5G and LTE in a home or visited network; and
wherein the third network node is an AMF.

14. (canceled)

15. The method according to claim 9, wherein the fourth network node is a mobility management entity, MME; and
wherein the second type is non-IP type.

16. A method in a second network node comprising:
receiving, from a first network node, a second request for establishment of a first connection that is a connection of a first type according to a first technology for a terminal device, the first request comprising a first indication about whether the terminal device supports a second connection that is a connection of the first type according to a second technology;
determining a second indication about whether the second connection is supported by the second network node; and
sending the second indication to the first network node.

17. The method according to claim 16, wherein the second indication is about whether the second connection is supported by both the terminal device and the second network node.

18. The method according to claim 16, wherein the second request is received from the first network node via a third network node; and
wherein the second indication is sent to the first network node via the third network node.

19. The method according to claim 16, further comprising:
receiving, from the first network node, a third indication about whether a fourth network node supports the second connection;
determining a fourth indication about whether the second connection or a third connection that is a connection of a second type according to the second technology is to be used for the terminal device, based on the first and third indications; and
sending the fourth indication to the first network node.

20. The method according to claim 19, wherein determining the fourth indication comprises:
when the terminal device, the second network node and the fourth network node support the second connection, determining that the second connection is to be used for the terminal device; and
when the fourth network node supports the third connection but does not support the second connection, determining that the third connection is to be used for the terminal device.

21. The method according to claim 16, wherein the first type is Ethernet type; and
wherein the first technology is 5th generation, 5G, and the second technology is long term evolution, LTE.

22. (canceled)

23. The method according to claim 16, wherein the first connection is a protocol data unit, PDU, session, of Ethernet type and the second connection is a packet data network, PDN, connection of Ethernet type.

24. The method according to claim 16, wherein the first network node is an access and mobility management function, AMF;
wherein the second network node is a session management node supporting both 5G and LTE in a home or visited network; and
wherein the third network node is a session management function, SMF, in a visited network; and
wherein the fourth network node is a mobility management entity, MME; and
wherein the second type is non-IP type.

25. (canceled)

26. A terminal device comprising:
at least one processor; and
at least one memory, the at least one memory containing instructions executable by the at least one processor, whereby the terminal device is operative to:
send, to a first network node, a first request for establishment of a first connection that is a connection of a first type according to a first technology, the first request comprising a first indication about whether the terminal device supports a second connection that is a connection of the first type according to a second technology; and
receive, from the first network node, a response to the first request, the response comprising a second indication about whether the second connection is supported by a second network node.

27. (canceled)

28. A first network node comprising:
at least one processor; and
at least one memory, the at least one memory containing instructions executable by the at least one processor, whereby the first network node is operative to:
receive, from a terminal device, a first request for establishment of a first connection that is a connection of a first type according to a first technology, the first request comprising a first indication about whether the terminal device supports a second connection that is a connection of the first type according to a second technology;
send, to a second network node, a second request for establishment of the first connection, the second request comprising the first indication;
receive, from the second network node, a second indication about whether the second connection is supported by the second network node; and
send the second indication to the terminal device.

29. (canceled)

30. A second network node comprising:
at least one processor; and
at least one memory, the at least one memory containing instructions executable by the at least one processor, whereby the second network node is operative to:
receive, from a first network node, a second request for establishment of a first connection that is a connection of a first type according to a first technology for a terminal device, the first request comprising a first indication about whether the terminal device supports a second connection that is a connection of the first type according to a second technology;
determine a second indication about whether the second connection is supported by the second network node; and
send the second indication to the first network node.

31. (canceled)

32. (canceled)
